(19) United States
(12) Patent Application Publication
(10) Pub. No.: US 2014/0184978 A1
(43) Pub. Date: Jul. 3, 2014

(54) SLIM BEZEL LIQUID CRYSTAL DISPLAY DEVICE

(71) Applicant: Shenzhen China Star Optoelectronics Technology Co. Ltd., Shenzhen, Guangdong (CN)

(72) Inventors: Gang Yu, Shenzhen City (CN); Liuyang Yang, Shenzhen City (CN)

(73) Assignee: Shenzen China Star Optoelectronics Technology Co., Ltd., Shenzhen, Guangdong (CN)

(21) Appl. No.: 13/704,022

(22) PCT Filed: Nov. 1, 2012
(86) PCT No.: PCT/CN2012/083900

§ 371 Date: Dec. 13, 2012

(30) Foreign Application Priority Data
Oct. 17, 2012 (CN) 201210395131.5

(51) Int. Cl. G02F 1/1333

(52) U.S. Cl. CPC G02F 1/133308
USPC 349/58

(57) ABSTRACT

The present invention provides a slim bezel liquid crystal display device, which includes a rear enclosure, a front enclosure mating the rear enclosure, and a liquid crystal display module arranged in the rear enclosure. The liquid crystal display module has four sides each forming a plurality of projections. The rear enclosure forms retention slots corresponding to the projections. The projections are receivable in and retained by the retention slots to fix the liquid crystal display module in the rear enclosure. With the projections formed on the liquid crystal display module and the retention slots formed in a rear enclosure, the projections are respectively receivable in and retained by the retention slots to fix the liquid crystal display module in the rear enclosure. The structure is simple and the assembling operation is easy so as to effectively achieve bezel slimming and device thinning of a liquid crystal display device.

### BACKGROUND OF THE INVENTION

1. Field of the Invention

The present invention relates to the field of liquid crystal displaying, and in particular to a slim bezel liquid crystal display device.

2. The Related Arts

Liquid crystal display (LCD) has numerous advantages, such as thin device body, less power consumption, and being free of radiation, and is thus widely used. Most of the liquid crystal display devices that are available in the market are backlighting liquid crystal displays, which comprise a liquid crystal display panel and a backlight module. The operation principle of the liquid crystal display panel is that liquid crystal molecules are arranged between two parallel glass substrates and electricity is selectively applied to the glass substrates to cause change of the orientation of the liquid crystal molecules in order to refract out the light from a backlight module for formation of an image.

A conventional liquid crystal display device generally comprises a rear enclosure, a front enclosure that mates the rear enclosure and a liquid crystal display module arranged in the rear enclosure. The liquid crystal display module is often fixed inside the rear enclosure by being screwed from the front side to the rear side. And then, the front enclosure is fit to the rear enclosure. Referring to FIG. 1, a schematic view is given to show an assembling structure of a conventional liquid crystal display module, which comprises an outer frame 100 forming bolt mounting zones 300. The bolt mounting zones 300 form bolt holes 500 and bolts are received through the bolt holes 500 to fix the liquid crystal display module in the rear enclosure. Due to the arrangement of the bolt mounting zones 300, the front enclosure needs a wide bezel to cover the bolt mounting zones 300. Consequently, a non-display zone of the liquid crystal display device is expanded and a display zone 700 is thus reduced. Further, since the manner of fixing is done by screwing from the front side to the rear side, the thickness of the liquid crystal display device is thus increased. With the constant progress of the manufacturing techniques of liquid crystal display device, the trend of development of liquid crystal display device is now toward bezel slimming and device thinning. The manner of fixing the liquid crystal display module to the rear enclosure affects the bezel width and overall thickness of the liquid crystal display device to quite an extent.

### SUMMARY OF THE INVENTION

An object of the present invention is to provide a slim bezel liquid crystal display device, which has a simple structure, is easy to maintain, can effectively realize bezel slimming and device thinning of the liquid crystal display device, and is capable of effectively controlling maintenance cost.

To achieve the object, the present invention provides a slim bezel liquid crystal display device, which comprises a rear enclosure, a front enclosure mating the rear enclosure, and a liquid crystal display module arranged in the rear enclosure. The liquid crystal display module has four sides each forming a plurality of projections. The rear enclosure forms retention slots corresponding to the projections. The projections are receivable in and retained by the retention slots to fix the liquid crystal display module in the rear enclosure.

The liquid crystal display module comprises a back frame and a liquid crystal display panel received in the back frame.

The back frame comprises a base board and four first side boards connected to the base board. The projections are formed on outside surfaces of the first side boards.

The rear enclosure comprises a bottom board and four second side boards connected to the bottom board.

The retention slots are formed in inside surfaces of the second side boards to respectively oppose the projections.

The projections are formed at ends of the first side boards that are adjacent to the base board and extend upward in an inclined manner and each comprises a slope surface. The slope surfaces are arranged to respectively oppose the retention slots.

The retention slots are rectangular recesses.

The liquid crystal display module further comprises a backlight module arranged inside the back frame. The backlight module provides a uniformly distributed planar light source to the liquid crystal display panel.

The present invention also provides a slim bezel liquid crystal display device, which comprises a rear enclosure, a front enclosure mating the rear enclosure, and a liquid crystal display module arranged in the rear enclosure, the liquid crystal display module having four sides each forming a plurality of projections, the rear enclosure forming retention slots corresponding to the projections, the projections being receivable in and retained by the retention slots to fix the liquid crystal display module in the rear enclosure;

wherein the liquid crystal display module comprises a back frame and a liquid crystal display panel received in the back frame;

wherein the back frame comprises a base board and four first side boards connected to the base board, the projections being formed on outside surfaces of the first side boards;

wherein the rear enclosure comprises a bottom board and four second side boards connected to the bottom board;

wherein the retention slots are formed in inside surfaces of the second side boards to respectively oppose the projections;

wherein the projections are formed at ends of the first side boards that are adjacent to the base board and extend upward in an inclined manner and each comprises a slope surface, the slope surfaces being arranged to respectively oppose the retention slots;

wherein he retention slots are rectangular recesses; and

wherein the liquid crystal display module further comprises a backlight module arranged inside the back frame, the backlight module providing a uniformly distributed planar light source to the liquid crystal display panel.

The efficacy of the present invention is that the present invention provides a slim bezel liquid crystal display device that comprises projections formed on a liquid crystal display module and retention slots formed in a rear enclosure, whereby the projections are respectively receivable in and retained by the retention slots to fix the liquid crystal display module in the rear enclosure. The structure is simple and the assembling operation is easy so as to effectively achieve bezel slimming and device thinning of a liquid crystal display device. Further, easy disassembling can be done with the liquid crystal display module in case of maintenance and replacement so that the maintenance cost can be effectively controlled.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, of the present invention will be apparent from the following detailed description of an embodiment of the present invention, with reference to the attached drawings. In the drawings:

FIG. 1 is a schematic view showing an assembling structure of a conventional liquid crystal display module;

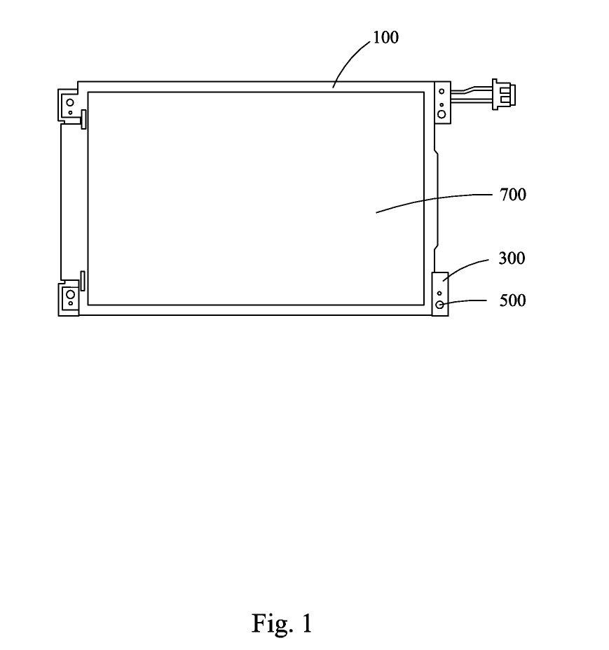

FIG. 2 is an exploded view showing a slim bezel liquid crystal display device according to a preferred embodiment of the present invention; and

FIG. 3 is a cross-sectional view showing engagement between a projection and a retention slot of the slim bezel liquid crystal display device according to the present invention.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

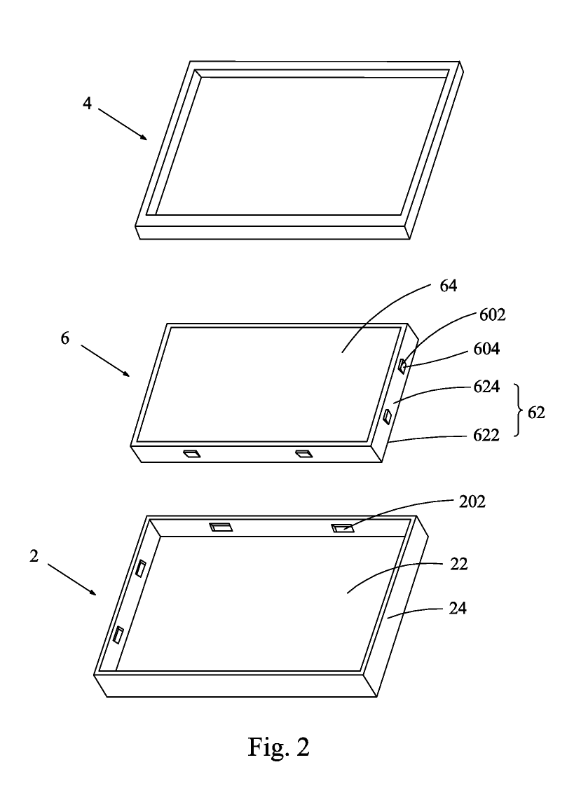

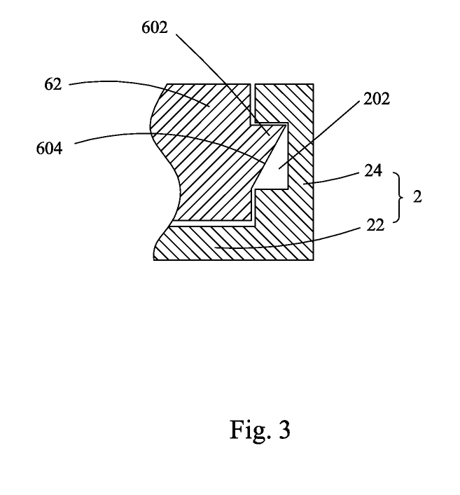

Referring to FIGS. 2 and 3, the present invention provides a slim bezel liquid crystal display device, which comprises a rear enclosure 2, a front enclosure 4 mating the rear enclosure 2, and a liquid crystal display module 6 arranged inside the rear enclosure 2. The liquid crystal display module 4 has four sides each forming a plurality of projections 602. The rear enclosure 2 forms retention slots 202 respectively corresponding to the projections 602. The projections 602 are receivable in and retained by the retention slots 202 so as to fix the liquid crystal display module 6 in the rear enclosure 2.

The liquid crystal display module 6 comprises a back frame 62 and a liquid crystal display panel 64 received in the back frame 62. The back frame 62 comprises a base board 622 and four first side boards 624 connected to the base board 622. The projections 602 are formed on outside surfaces of the first side boards 624. In the instant embodiment, the projections 602 are formed at the ends of the first side boards 624 that are adjacent to the base board 622 and extending upward in an inclined manner and comprise a slope surface 604. The slope surfaces 604 are arranged to respectively oppose the retention slots 202.

The rear enclosure 2 comprises a bottom board 22 and four second side boards 24 connected to the bottom board 22. The retention slots 202 are formed in inside surfaces of the second side boards 24 to respectively oppose the projections 602. In the instant embodiment, the retention slots 202 are rectangular recesses.

The projections 602 and the retention slots 202 are of a number determined according to practical needs. In the instant embodiment, the projections 602 are eight that are averagely distributed on the four first side boards 624. The retention slots 202 are formed in the second side boards 24 and also eight to correspond to the projections 602.

To assemble, the liquid crystal display module 6 is directly pressed down toward the rear enclosure 2 to allow the projections 602 to slide into the retention slots 202. To disassemble, the second side boards 24 are outward deflected at free ends thereof and at the same time, the liquid crystal display module 6 is lifted upward to cause the liquid crystal display module to slide off the retention slots 202 so as to separate the liquid crystal display module 6 and rear enclosure 2. The assembling and disassembling operation are both easy so that the operation time can be effectively saved.

The liquid crystal display module 6 further comprises a backlight module (not shown) arranged inside the back frame 62. The backlight module provides a uniformly distributed planar light source to the liquid crystal display panel 64 to ensure normal operation of the liquid crystal display module 6.

In summary, the present invention provides a slim bezel liquid crystal display device that comprises projections formed on a liquid crystal display module and retention slots formed in a rear enclosure, whereby the projections are respectively receivable in and retained by the retention slots to fix the liquid crystal display module in the rear enclosure. The structure is simple and the assembling operation is easy so as to effectively achieve bezel slimming and device thinning of a liquid crystal display device. Further, easy disassembling can be done with the liquid crystal display module in case of maintenance and replacement so that the maintenance cost can be effectively controlled.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A slim bezel liquid crystal display device, comprising a rear enclosure, a front enclosure mating the rear enclosure, and a liquid crystal display module arranged in the rear enclosure, the liquid crystal display module having four sides each forming a plurality of projections, the rear enclosure forming retention slots corresponding to the projections, the projections being receivable in and retained by the retention slots to fix the liquid crystal display module in the rear enclosure.

2. The slim bezel liquid crystal display device as claimed in claim 1, wherein the liquid crystal display module comprises a back frame and a liquid crystal display panel received in the back frame.

3. The slim bezel liquid crystal display device as claimed in claim 2, wherein the back frame comprises a base board and four first side boards connected to the base board, the projections being formed on outside surfaces of the first side boards.

4. The slim bezel liquid crystal display device as claimed in claim 3, wherein the rear enclosure comprises a bottom board and four second side boards connected to the bottom board.

5. The slim bezel liquid crystal display device as claimed in claim 4, wherein the retention slots are formed in inside surfaces of the second side boards to respectively oppose the projections.

6. The slim bezel liquid crystal display device as claimed in claim 3, wherein the projections are formed at ends of the first side boards that are adjacent to the base board and extend upward in an inclined manner and each comprises a slope surface, the slope surfaces being arranged to respectively oppose the retention slots.

7. The slim bezel liquid crystal display device as claimed in claim 6, wherein he retention slots are rectangular recesses.

8. The slim bezel liquid crystal display device as claimed in claim 2, wherein the liquid crystal display module further comprises a backlight module arranged inside the back frame, the backlight module providing a uniformly distributed planar light source to the liquid crystal display panel.

9. A slim bezel liquid crystal display device, comprising a rear enclosure, a front enclosure mating the rear enclosure, and a liquid crystal display module arranged in the rear enclosure, the liquid crystal display module having four sides each forming a plurality of projections, the rear enclosure forming retention slots corresponding to the projections, the projections being receivable in and retained by the retention slots to fix the liquid crystal display module in the rear enclosure;
wherein the liquid crystal display module comprises a back frame and a liquid crystal display panel received in the back frame;
wherein the back frame comprises a base board and four first side boards connected to the base board, the projections being formed on outside surfaces of the first side boards;
wherein the rear enclosure comprises a bottom board and four second side boards connected to the bottom board;
wherein the retention slots are formed in inside surfaces of the second side boards to respectively oppose the projections;
wherein the projections are formed at ends of the first side boards that are adjacent to the base board and extend upward in an inclined manner and each comprises a slope surface, the slope surfaces being arranged to respectively oppose the retention slots;
wherein he retention slots are rectangular recesses; and
wherein the liquid crystal display module further comprises a backlight module arranged inside the back frame, the backlight module providing a uniformly distributed planar light source to the liquid crystal display panel.
